(19) United States
(12) Patent Application Publication
(10) Pub. No.: US 2026/0090948 A1
(43) Pub. Date: Apr. 2, 2026

(54) REMOVABLE HOLDER WITH CONTROLLED MOVABLE MASSAGE MODULE FOR MASSAGE DEVICE WITH CARRIER ELEMENT

(71) Applicant: LIMITED LIABILITY COMPANY "SPEKTRIA", MOSCOW (RU)

(72) Inventor: Vitalii Georgievich MONAKU, Lakinsk (RU)

(21) Appl. No.: 18/936,569

(22) Filed: Nov. 4, 2024

(30) Foreign Application Priority Data
Oct. 2, 2024 (RU) 2024129566

(51) Int. Cl. A61H 15/00

(52) U.S. Cl. CPC A61H 15/0085; A61H 2015/0042; A61H 2201/1207; A61H 2201/1454

(57) ABSTRACT

The proposed technical solution relates to medical and/or sports equipment, in particular to means intended for performing body massage. A removable holder with a controlled movable massage module for a massage device with a carrier element is proposed. The technical result achieved by implementing the claimed invention, in addition to implementing its purpose, is the elimination of the shortcomings of the closest analogue and thus increasing the efficiency of using the massage device, expanding the functional capabilities of the massage device and providing the ability to control the angle of inclination of the massage element directly during operation and/or providing the ability to automatically change the angle of inclination of the massage element directly during operation.

### FIELD OF INVENTION

The proposed invention relates to medical and/or sports equipment, particularly to means for body massage.

### DESCRIPTION OF THE RELATED ART

There is a conventional massage device described in patent document RU2820979C2 [D1]. The massage device disclosed in D1 comprises a base with an intermediate element on which there is a bearing element for holders. At the same time the bearing element for holders is made with built-in holders, each of which is a recess in the bearing element and is made with possibility of placement in the recess of the massage element and changing the distance between the massage elements. Besides, bearing element can accommodate detachable holders and extensions for them with holes for ledges in lower part of holders. Each of the detachable holders is a body with one or more recesses in the body and is configured to be placed in the corresponding recess of the massage element, changing the distance between the massage elements and with the possibility of changing the angle of inclination of the massage elements to the central longitudinal axis of the device.

In the solution of D1, massage elements are predominantly static, and their position is changed manually.

### SUMMARY OF THE INVENTION

The technical problem to be solved by the claimed invention, in addition to expanding the available technical means for body massage, is to provide a massage device that does not possess the drawbacks of the prior art and thus has increased efficiency, expanded functionality, and enables the tilt angle of a massage element to be directly controlled during operation and/or to be automatically adjusted directly during operation.

The objective of the claimed invention, in addition to fulfilling its purpose, is to eliminate the drawbacks of the prior art and thus to make a massage device more efficient, to expand its functionality and to enable the tilt angle of a massage element to be directly controlled during operation and/or to be automatically adjusted directly during operation.

The objective of the present invention is achieved by a detachable holder for a guided movable massage module, which is represented by a body having one or more recesses, wherein at least one of the recesses is adapted to bear the guided movable massage module with at least one recess for a massage element; the guided movable massage module is represented by a holder placed on stands, configured to be turned in longitudinal direction, the holder having at least one recess, a balancing magnet on one side, and a turning magnet on the other side; wherein the body of the detachable holder holds an electric actuator that is controlled by a controller and at least one shaft adapted to at least partially rotate around its longitudinal axis, the shaft being equipped with an opposing magnet for the at least one turning magnet for turning the massage module; wherein the body is equipped with an opposing magnet for the balancing magnet on the side of the balancing magnet of the massage module; wherein the shaft equipped with the opposing magnet is placed, so as to interact with the turning magnet, when turned to a given position, prompting the massage module to rotate around its longitudinal axis toward the shaft's opposing magnet; and wherein the balancing magnet and the body's opposing magnet are placed, so as to ensure that the massage module returns after turning to at least its initial position; also, the detachable holder is designed to be used with a massage device comprising a base that has a bearing element for holders, wherein the bearing element for holders has built-in holders, each built-in holder being a recess in the bearing element, adapted to be placed in a recess of a massage element, and is adapted to bear detachable holders.

### BRIEF DESCRIPTION OF THE DRAWINGS

Exemplary embodiments of the present invention are described in further detail below with references made to the attached drawings, included herein by reference:

FIG. 1, for example, but not limited to, shows an exemplary proposed detachable holder with massage modules removed.

FIG. 2, for example, but not limited to, shows an exemplary proposed detachable holder with massage modules mounted.

FIG. 3, for example, but not limited to, shows an exemplary diagram of component placement inside a detachable holder.

### DETAILED DESCRIPTION OF THE PREFERRED EMBODIMENTS

According to a preferred embodiment of the present invention, there is provided a massage device comprising a base with an intermediate element mounted on it that has a bearing element for holders, wherein the bearing element for holders has built-in holders, each built-in holder being a recess in the bearing element, adapted to be placed in a recess of a massage element, and is adapted to bear detachable holders, each detachable holder being a body with one or more recesses, characterized in that at least one of the recesses is adapted to bear a guided movable massage module with at least one recess for a massage element; the guided movable massage module is represented by a holder placed on stands, configured to be turned in longitudinal direction, the holder having at least one recess, a balancing magnet on one side, and a turning magnet on the other side; wherein the body of the detachable holder holds an electric actuator that is controlled by a controller and at least one shaft adapted to at least partially rotate around its longitudinal axis, the shaft being equipped with an opposing magnet for the at least one turning magnet for turning the massage module; wherein the body is equipped with an opposing magnet for the balancing magnet on the side of the balancing magnet of the massage module; wherein the shaft equipped with the opposing magnet is placed, so as to interact with the turning magnet, when turned to a given position, prompting the massage module to rotate around its longitudinal axis toward the shaft's opposing magnet; and wherein the balancing magnet and the body's opposing magnet are placed, so as to ensure that the massage module returns after turning to at least its initial position.

According to another preferred embodiment of the present invention, there is provided a massage device comprising a base that has a bearing element for holders, wherein the bearing element for holders has built-in holders, each built-in holder being a recess in the bearing element, adapted to be placed in a recess of a massage element, and is adapted to bear detachable holders, each detachable holder being a body with one or more recesses, characterized in that at least one of the recesses is adapted to bear a guided movable massage module with at least one recess for a massage element; the guided movable massage module is represented by a holder placed on stands, configured to be turned in longitudinal direction, the holder having at least one recess, a balancing magnet on one side, and a turning magnet on the other side; wherein the body of the detachable holder holds an electric actuator that is controlled by a controller and at least one shaft adapted to at least partially rotate around its longitudinal axis, the shaft being equipped with an opposing magnet for the at least one turning magnet for turning the massage module; wherein the body is equipped with an opposing magnet for the balancing magnet on the side of the balancing magnet of the massage module; wherein the shaft equipped with the opposing magnet is placed, so as to interact with the turning magnet, when turned to a given position, prompting the massage module to rotate around its longitudinal axis toward the shaft's opposing magnet; and wherein the balancing magnet and the body's opposing magnet are placed, so as to ensure that the massage module returns after turning to at least its initial position.

According to another preferred embodiment of the present invention, there is provided a massage device comprising a base, which is represented by a bearing element for holders, wherein the bearing element for holders has built-in holders, each built-in holder being a recess in the bearing element, adapted to be placed in a recess of a massage element, and is adapted to bear detachable holders, each detachable holder being a body with one or more recesses, characterized in that at least one of the recesses is adapted to bear a guided movable massage module with at least one recess for a massage element; the guided movable massage module is represented by a holder placed on stands, configured to be turned in longitudinal direction, the holder having at least one recess, a balancing magnet on one side, and a turning magnet on the other side; wherein the body of the detachable holder holds an electric actuator that is controlled by a controller and at least one shaft adapted to at least partially rotate around its longitudinal axis, the shaft being equipped with an opposing magnet for the at least one turning magnet for turning the massage module; wherein the body is equipped with an opposing magnet for the balancing magnet on the side of the balancing magnet of the massage module; wherein the shaft equipped with the opposing magnet is placed, so as to interact with the turning magnet, when turned to a given position, prompting the massage module to rotate around its longitudinal axis toward the shaft's opposing magnet; and wherein the balancing magnet and the body's opposing magnet are placed, so as to ensure that the massage module returns after turning to at least its initial position.

According to another preferred embodiment of the present invention, there is provided a detachable holder for a guided movable massage module, which is represented by a body having one or more recesses, wherein at least one of the recesses is adapted to bear the guided movable massage module with at least one recess for a massage element; the guided movable massage module is represented by a holder placed on stands, configured to be turned in longitudinal direction, the holder having at least one recess, a balancing magnet on one side, and a turning magnet on the other side; wherein the body of the detachable holder holds an electric actuator that is controlled by a controller and at least one shaft adapted to at least partially rotate around its longitudinal axis, the shaft being equipped with an opposing magnet for the at least one turning magnet for turning the massage module; wherein the body is equipped with an opposing magnet for the balancing magnet on the side of the balancing magnet of the massage module; wherein the shaft equipped with the opposing magnet is placed, so as to interact with the turning magnet, when turned to a given position, prompting the massage module to rotate around its longitudinal axis toward the shaft's opposing magnet; and wherein the balancing magnet and the body's opposing magnet are placed, so as to ensure that the massage module returns after turning to at least its initial position; also, the detachable holder is designed to be used with a massage device comprising a base with an intermediate element mounted on it that has a bearing element for holders, wherein the bearing element for holders has built-in holders, each built-in holder being a recess in the bearing element, adapted to be placed in a recess of a massage element, and is adapted to bear detachable holders designed for it.

According to another preferred embodiment of the present invention, there is provided a detachable holder for a guided movable massage module, which is represented by a body having one or more recesses, wherein at least one of the recesses is adapted to bear the guided movable massage module with at least one recess for a massage element; the guided movable massage module is represented by a holder placed on stands, configured to be turned in longitudinal direction, the holder having at least one recess, a balancing magnet on one side, and a turning magnet on the other side; wherein the body of the detachable holder holds an electric actuator that is controlled by a controller and at least one shaft adapted to at least partially rotate around its longitudinal axis, the shaft being equipped with an opposing magnet for the at least one turning magnet for turning the massage module; wherein the body is equipped with an opposing magnet for the balancing magnet on the side of the balancing magnet of the massage module; wherein the shaft equipped with the opposing magnet is placed, so as to interact with the turning magnet, when turned to a given position, prompting the massage module to rotate around its longitudinal axis toward the shaft's opposing magnet; and wherein the balancing magnet and the body's opposing magnet are placed, so as to ensure that the massage module returns after turning to at least its initial position; also, the detachable holder is designed to be used with a massage device comprising a base that has a bearing element for holders, wherein the bearing element for holders has built-in holders, each built-in holder being a recess in the bearing element, adapted to be placed in a recess of a massage element, and is adapted to bear detachable holders.

According to another preferred embodiment of the present invention, there is provided a detachable holder for a guided movable massage module, which is represented by a body having one or more recesses, wherein at least one of the recesses is adapted to bear the guided movable massage module with at least one recess for a massage element; the guided movable massage module is represented by a holder placed on stands, configured to be turned in longitudinal direction, the holder having at least one recess, a balancing magnet on one side, and a turning magnet on the other side; wherein the body of the detachable holder holds an electric actuator that is controlled by a controller and at least one shaft adapted to at least partially rotate around its longitudinal axis, the shaft being equipped with an opposing magnet for the at least one turning magnet for turning the massage module; wherein the body is equipped with an opposing magnet for the balancing magnet on the side of the balancing magnet of the massage module; wherein the shaft equipped with the opposing magnet is placed, so as to interact with the turning magnet, when turned to a given position, prompting the massage module to rotate around its longitudinal axis toward the shaft's opposing magnet; and wherein the balancing magnet and the body's opposing magnet are placed, so as to ensure that the massage module returns after turning to at least its initial position; also, the detachable holder is designed to be used with a massage device comprising a base that has a bearing element for holders, wherein the bearing element for holders has built-in holders, each built-in holder being a recess in the bearing element, adapted to be placed in a recess of a massage element, and is adapted to bear detachable holders.

According to another preferred embodiment of the present invention, there is provided a detachable holder for a guided movable massage module, the holder being represented by a body with one or more recesses, wherein at least one of the recesses is adapted to bear the guided movable massage module with at least one recess for a massage element; the guided movable massage module is represented by a holder placed on stands, configured to be turned in longitudinal direction, the holder having at least one recess, a balancing magnet on one side, and a turning magnet on the other side; wherein the body of the detachable holder holds an electric actuator that is controlled by a controller and at least one shaft adapted to at least partially rotate around its longitudinal axis, the shaft being equipped with an opposing magnet for the at least one turning magnet for turning the massage module; wherein the body is equipped with an opposing magnet for the balancing magnet on the side of the balancing magnet of the massage module; wherein the shaft equipped with the opposing magnet is placed, so as to interact with the turning magnet, when turned to a given position, prompting the massage module to rotate around its longitudinal axis toward the shaft's opposing magnet; and wherein the balancing magnet and the body's opposing magnet are placed, so as to ensure that the massage module returns after turning to at least its initial position; also, the detachable holder is adapted to be placed on a bearing element equipped with recesses for detachable holders.

Additional alternative embodiments of the present invention are provided below. This disclosure is in no way limiting to the scope of protection granted by the present patent. Rather, it should be noted that the claimed invention can be implemented in different ways, so as to include different components and conditions, or combinations thereof, which are similar to the components and conditions disclosed herein, in combination with other existing and future technologies.

Preferably, but not limited to, the disclosed massage device is basically similar to the massage device of patent document RU2820979C2, published on Jun. 14, 2024, Bulletin No. 17, described above, which is, therefore, fully included herein by reference.

In an exemplary embodiment, preferably, but not limited to, the massage device comprises at least a base with an intermediary element mounted on it that has a bearing element for holders, wherein the bearing element for holders has built-in holders, each built-in holder being a recess in the bearing element, adapted to be placed in a recess of a massage element, and is adapted to bear detachable holders.

In another exemplary embodiment, preferably, but not limited to, the massage device comprises at least a base that has a bearing element for holders, wherein the bearing element for holders has built-in holders, each built-in holder being a recess in the bearing element, adapted to be placed in a recess of a massage element, and is adapted to bear detachable holders.

In another exemplary embodiment, preferably, but not limited to, the massage device comprises at least a base which is represented by a bearing element for holders, wherein the bearing element for holders has built-in holders, each built-in holder being a recess in the bearing element, adapted to be placed in a recess of a massage element, and is adapted to bear detachable holders.

At the same time, it should be generally noted that different embodiments of the massage device provide massage elements with different plane stiffness, respectively. For instance, but not limited to, when the massage device is equipped with an intermediate element, such an intermediate element, preferably, but not limited to, provides elasticity for the bearing element for massage elements. Also, less elasticity can be provided if the intermediate element is removed, and the bearing element will be made with a certain stiffness, which is different from the stiffness of the base carrying the bearing element. Finally, but not limited to, constant stiffness can be provided, if the base itself acts as a bearing element.

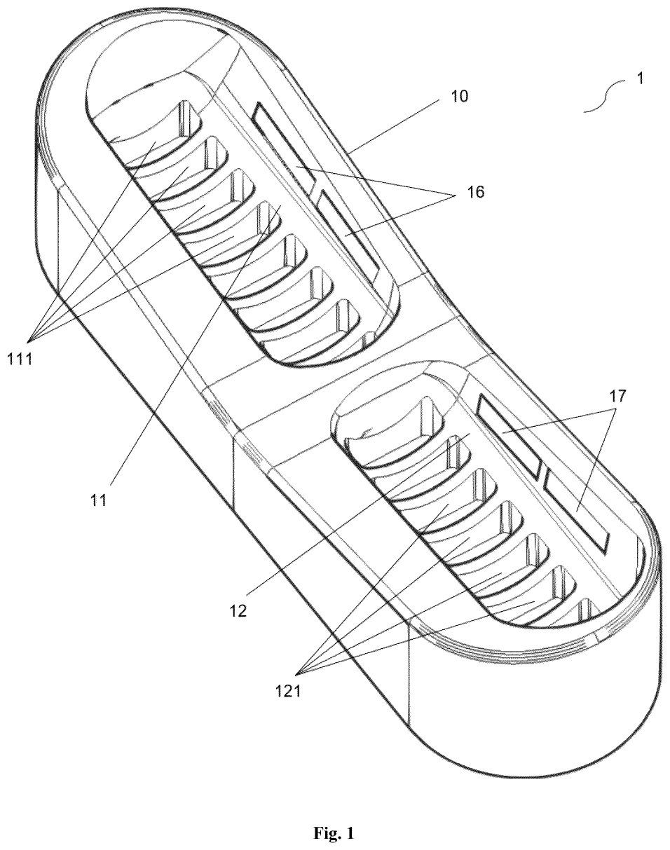

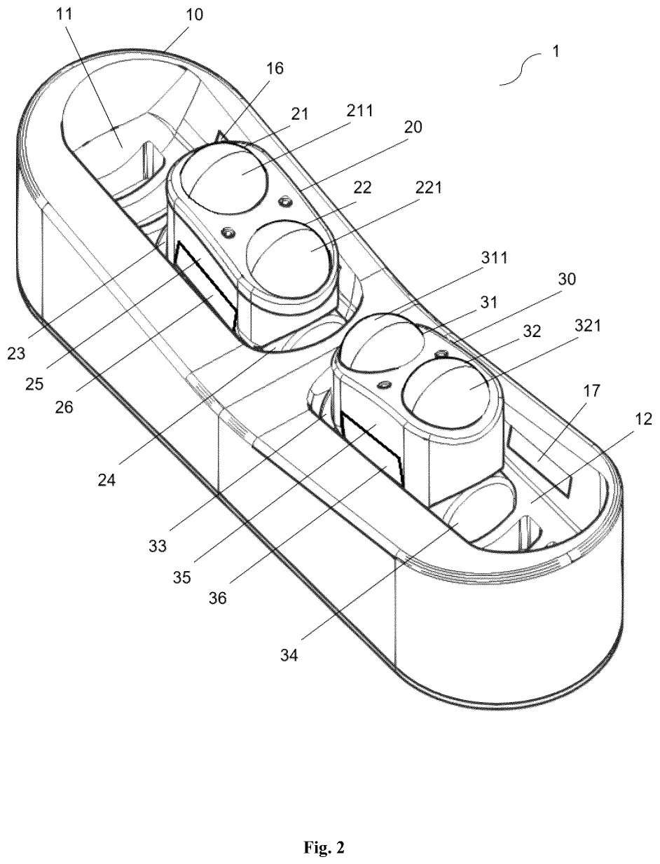

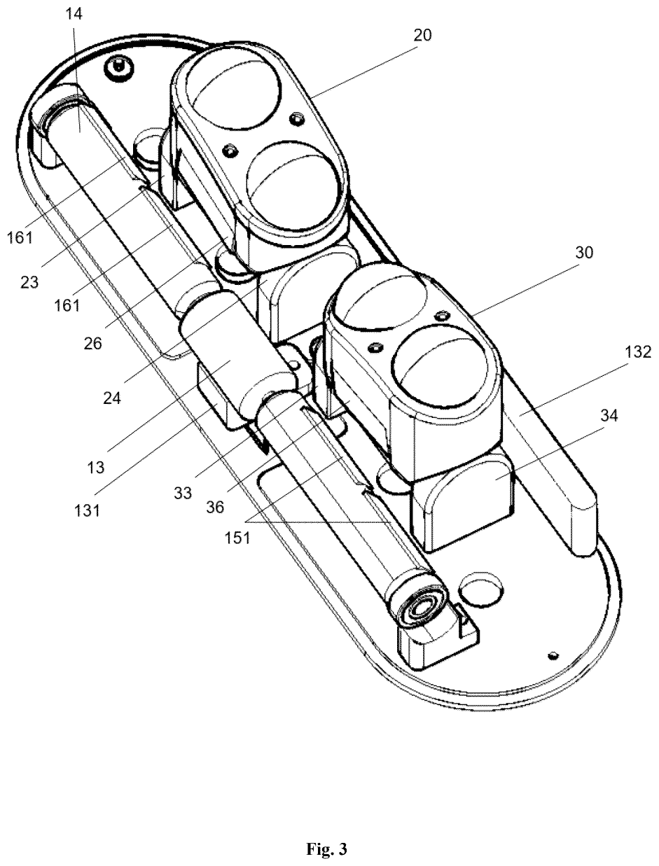

In addition, but not limited to, the proposed invention differs from the prior art in that a guided movable massage module 20, 30 and a detachable holder 1, specifically designed for it, are used. FIG. 1, for example, but not limited to, shows an exemplary proposed detachable holder 1 with massage modules 20, 30 removed. FIG. 2, for example, but not limited to, shows an exemplary proposed detachable holder 1 with massage modules 20, 30 mounted. FIG. 3, for example, but not limited to, shows an exemplary diagram of component placement inside a detachable holder 1. Preferably, but not limited to, as shown in FIGS. 1-3, the detachable holder 1 is a body 10 with one or more recesses 11, 12, characterized in that at least one of the recesses 11, 12 is adapted to bear a guided movable massage module 20, 30 with at least one recess 21, 22, 31, 32 for a massage element 211, 221, 311, 321; the guided movable massage module 20, 30 is represented by a holder 25, 35 placed on stands 23, 24, 33, 34, configured to be turned in longitudinal direction, the holder 25, 35 having at least one recess 21, 22, 31, 32, a balancing magnet on one side (not shown in the drawing), and a turning magnet 26, 36 on the other side; wherein the body 10 of the detachable holder 1 holds an electric actuator 13 that is controlled by a controller and at least one shaft 14, 15 adapted to at least partially rotate around its longitudinal axis, the shaft 14, 15 being equipped with an opposing magnet 141, 151 for the at least one turning magnet 26, 36 for turning the massage module 20, 30; wherein the body 10 is equipped with an opposing magnet 16, 17 for the balancing magnet on the side of the balancing magnet of the massage module 20, 30; wherein the shaft 14, 15 equipped with the opposing magnet 141, 151 is placed, so as to interact with the turning magnet 26, 36, when turned to a given position, prompting the massage module 20, 30 to rotate around its longitudinal axis toward the opposing magnet 141, 151 of the shaft 14, 15; and wherein the balancing magnet and the opposing magnet 16, 17 of the body 10 are placed, so as to ensure that the massage module 20, 30 returns after turning to at least its initial position. In addition, but not limited to, the electric shaft 13 can be equipped with a control unit 131 and a power source 132 that are connected electrically and via a data bus. In addition, but not limited to, any suitable power source can be chosen as power source 132, for example, an autonomous one that uses electric batteries or rechargeable batteries, or storage batteries, or it can be a grid-powered transformer, etc. In addition, but not limited to, the control unit 131 is a customizable multifunctional electronic device, and it is set up to allow the at least one shaft 14, 15 to at least rotate in both directions so that at least one magnet 141, 151 of the shaft can interact with the turning magnet 26, 36, so that the corresponding guided movable massage module 20, 30 is rotated around its longitudinal axis on the corresponding stands 23, 24, 33, 34 at the location where it is connected to the corresponding stands 23, 24, 33, 34; wherein, but not limited to, the rotation of the shaft 14, 15 can be controlled by means of an external control panel that is connected to the control unit 131 via a wireless communication line, or it can be controlled by pressing an input device (not shown in the drawing) on the body of the detachable holder 1. Also, this may allow to select a specific mode and/or script for the rotation of the shaft 14, 15. The massage element 40, 50, 60, 70 can be made in any suitable shape as was described in RU2820979C2, for example, but not limited to, it can have the shape of a ball, or a convex-ended cylinder, including one that has variable section predominantly in its middle; wherein it should be generally noted that the shape of the element 211, 221, 311, 321 is determined by the shape of the corresponding recess 21, 22, 31, 32. In addition, but not limited to, any of the recesses 11, 12 in the body 10 can be provided with slots 111, 121 for the corresponding stands 23, 24, 33, 34, configured in such a way so as to make it possible to mount a guided movable massage module 20, 30 in the corresponding recess 11, 12 with a shift, which, in addition to expanding functionality of the device, makes it possible to fine-tune the position of the corresponding massage module 20, 30 in a way that is most preferable for the user of the device.

At the same time, but not limited to, it should be obvious to a person having ordinary skill in the art that, instead of the massage device of RU2820979C2, any similar device can be chosen that enables mounting detachable holders, while mainly the choice of the device will be determined only by its capability of bearing a detachable holder 1, or more specifically, its body 10.

The present disclosure of the claimed invention demonstrates only certain exemplary embodiments of the invention, which by no means limit the scope of the claimed invention, meaning that it may be embodied in alternative forms that do not go beyond the scope of the present disclosure and which may be obvious to persons having ordinary skill in the art.

1. A detachable holder for a guided movable massage module, which is represented by a body having one or more recesses, wherein at least one of the recesses is adapted to bear the guided movable massage module with at least one recess for a massage element; the guided movable massage module is represented by a holder placed on stands, configured to be turned in longitudinal direction, the holder having at least one recess, a balancing magnet on one side, and a turning magnet on the other side; wherein the body of the detachable holder holds an electric actuator that is controlled by a controller and at least one shaft adapted to at least partially rotate around its longitudinal axis, the shaft being equipped with an opposing magnet for the at least one turning magnet for turning the massage module; wherein the body is equipped with an opposing magnet for the balancing magnet on the side of the balancing magnet of the massage module; wherein the shaft equipped with the opposing magnet is placed, so as to interact with the turning magnet, when turned to a given position, prompting the massage module to rotate around its longitudinal axis toward the shaft's opposing magnet; and wherein the balancing magnet and the body's opposing magnet are placed, so as to ensure that the massage module returns after turning to at least its initial position; also, the detachable holder is designed to be used with a massage device comprising a base that has a bearing element for holders, wherein the bearing element for holders has built-in holders, each built-in holder being a recess in the bearing element, adapted to be placed in a recess of a massage element, and is adapted to bear detachable holders.
